(19) United States
(12) Patent Application Publication
(10) Pub. No.: US 2006/0266018 A1
(43) Pub. Date: Nov. 30, 2006

(54) EXHAUST CONTROL SYSTEM IMPLEMENTING SULFUR DETECTION

(75) Inventor: James Carl Durand, Dunlap, IL (US)

Correspondence Address: CATERPILLAR/FINNEGAN, HENDERSON, L.L.P., 901 New York Avenue, NW, WASHINGTON, DC, 20001-4413, US

(73) Assignee: Caterpillar Inc.

(21) Appl. No.: 11/139,605

(22) Filed: May 31, 2005

(51) Int. Cl. F01N 3/00; F02M 25/06; F01N 5/04

(52) U.S. Cl. 60/276; 60/278; 60/280

(57) ABSTRACT

An exhaust control system for a power source is disclosed. The exhaust system has an air induction system, an exhaust system, and a recirculation system. The recirculation system is configured to direct at least a portion of an exhaust flow from the exhaust system to the air induction system. The exhaust control system also has a sensor configured to detect the presence of sulfur, and a controller in communication with the sensor. The controller is configured to modify operation of the recirculation system in response to the detected presence of sulfur.

### TECHNICAL FIELD

The present disclosure relates generally to an exhaust control system and, more particularly, to an exhaust control system that implements sulfur detection.

### BACKGROUND

Internal combustion engines, including diesel engines, gasoline engines, gaseous fuel-powered engines, and other engines known in the art, may exhaust a complex mixture of air pollutants. The air pollutants may be composed of gaseous compounds and solid particulate matter.

Due to increased attention on the environment, exhaust emission standards have become more stringent, and the amount of pollutants emitted to the atmosphere from an engine may be regulated depending on the type of engine, size of engine, and/or class of engine. Many different exhaust treatment solutions may be implemented by engine manufacturers to comply with these regulations such as, for example, Exhaust Gas Recirculation (EGR) solutions, filtration solutions, catalyst solutions, and other such treatment solutions.

Some of the components of these exhaust treatment solutions may be adversely affected by the presence of sulfur in the exhaust emissions. In order to minimize the adverse affects of sulfur, methods have been developed to detect the presence of sulfur in the emissions and to change operation of the engine in response to the detection. For example, U.S. Pat. No. 6,772,587 (the '587 patent), issued to Manaka on Aug. 10, 2004, discloses an exhaust gas purification control apparatus having a NOx absorber and an exhaust sensor. The '587 patent discloses sensing a sulfur component in an exhaust gas, calculating a quantity of the sulfur component in the exhaust gas, and changing an air/fuel ratio of an engine based on the detected quantity of sulfur component. The air/fuel ratio is changed to limit lean operation of the engine that could result in poisoning of the NOx absorber when sulfur is present.

Although the exhaust gas purification control apparatus of the '587 patent may limit poisoning of a NOx absorber, it may be ineffectual for minimizing the adverse affects of sulfur presence on other components of an exhaust system. In particular, changing the air/fuel ratio of an engine may do little to minimize the adverse affects of sulfur on an EGR system or other components of an exhaust control system. In addition, because the apparatus of the '587 patent senses the presence of sulfur only in an exhaust gas, it may do little to protect components of the engine upstream of the exhaust gas.

The disclosed exhaust control system is directed to overcoming one or more of the problems set forth above.

### SUMMARY OF THE INVENTION

In one aspect, the present disclosure is directed to an exhaust control system for a power source. The exhaust control system includes an air induction system, an exhaust system, and a recirculation system. The recirculation system is configured to direct at least a portion of an exhaust flow from the exhaust system to the air induction system. The exhaust control system also includes a sensor configured to detect the presence of sulfur, and a controller in communication with the sensor. The controller is configured to modify operation of the recirculation system in response to the detected presence of sulfur.

In yet another aspect, the present disclosure is directed to a method of operating an exhaust control system. The method includes directing at least a portion of an exhaust flow from a power source back into the power source for subsequent combustion. The method further includes detecting a presence of sulfur and modifying an amount of the exhaust flow directed back into the power source in response to the detected presence of sulfur.

### BRIEF DESCRIPTION OF THE DRAWINGS

FIG. 1 is a diagrammatic illustration of a power source having an exhaust control system according to an exemplary disclosed embodiment.

### DETAILED DESCRIPTION

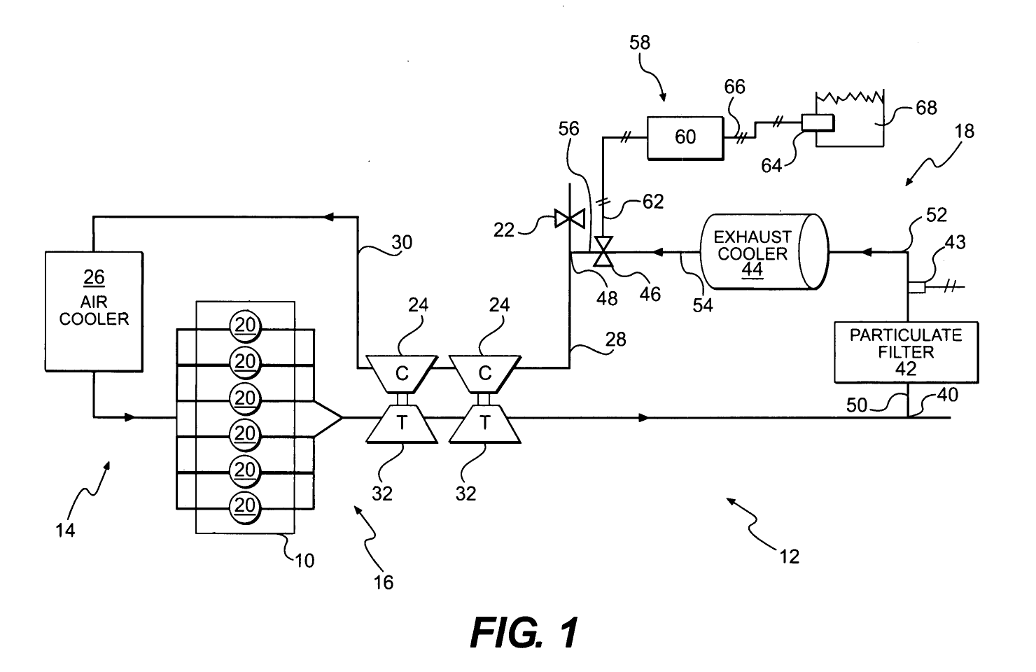

FIG. 1 illustrates a power source 10 having an exemplary exhaust control system 12. Power source 10 may include an engine such as, for example, a diesel engine, a gasoline engine, a gaseous fuel-powered engine such as a natural gas engine, or any other engine apparent to one skilled in the art. Power source 10 may, alternatively, include another source of power such as a furnace or another suitable source of power. Exhaust control system 12 may include an air induction system 14, an exhaust system 16, and a recirculation system 18.

Air induction system 14 may include a means for introducing charged air into a combustion chamber 20 of power source 10. For example, air induction system 14 may include a induction valve 22, one or more compressors 24, and an air cooler 26. It is contemplated that additional components may be included within air induction system 14 such as, for example, additional valving, one or more air cleaners, one or more waste gates, a control system, and other means for introducing charged air into combustion chambers 20 that are known in the art.

Induction valve 22 may be fluidly connected to compressors 24 via a fluid passageway 28 and configured to regulate the flow of atmospheric air to power source 10. Induction valve 22 may be a spool valve, a shutter valve, a butterfly valve, a check valve, a diaphragm valve, a gate valve, a shuttle valve, a ball valve, a globe valve, or any other type of valve known in the art. Induction valve 22 may be solenoid-actuated, hydraulically-actuated, pneumatically-actuated, or actuated in any other manner. Induction valve 22 may be in communication with a controller (not shown) and selectively actuated in response to one or more predetermined conditions.

Compressors 24 may be configured to compress the air flowing into power source 10 to a predetermined pressure level. Compressors 24 may be disposed in a series relationship and fluidly connected to power source 10 via a fluid passageway 30. Each of compressors 24 may include a fixed geometry compressor, a variable geometry compressor, or any other type of compressor known in the art. It is contemplated that compressors 24 may alternatively be disposed in a parallel relationship or that air induction system 14 may include only a single compressor 24.

It is further contemplated that compressors 24 may be omitted, when a non-pressurized air induction system is desired.

Air cooler 26 may be an air-to-air heat exchanger or an air-to-liquid heat exchanger and configured to facilitate the transfer of heat to or from the air directed into power source 10. For example, air cooler 26 may include a tube and shell type heat exchanger, a plate type heat exchanger, or any other type of heat exchanger known in the art. Air cooler 26 may be connected to power source 10 via fluid passageway 30.

Exhaust system 16 may include a means for directing exhaust flow out of power source 10. For example, exhaust system 16 may include one or more turbines 32 connected in a series relationship. It is contemplated that exhaust system 16 may include additional components such as, for example, emission controlling devices such as particulate traps, NOx absorbers, or other catalytic devices, attenuation devices, and other means for directing exhaust flow out of power source 10 that are known in the art.

Each turbine 32 may be connected to one compressor 24 and configured to drive the connected compressor 24. In particular, as the hot exhaust gases exiting power source 10 expand against blades (not shown) of turbine 32, turbine 32 may rotate and drive the connected compressor 24. It is contemplated that turbines 32 may alternatively be disposed in a parallel relationship or that only a single turbine 32 may be included within exhaust system 16. It is also contemplated that turbines 32 may be omitted and compressors 24 driven by power source 10 mechanically, hydraulically, electrically, or in any other manner known in the art, if desired.

Recirculation system 18 may include a means for redirecting a portion of the exhaust flow of power source 10 from exhaust system 16 into air induction system 14. For example, recirculation system 18 may include an inlet port 40, a recirculation particulate filter 42, a mass flow sensor 43, an exhaust cooler 44, a recirculation valve 46, and a discharge port 48. It is contemplated that recirculation system 18 may include additional or different components such as a catalyst, an electrostatic precipitation device, a shield gas system, and other means for redirecting that are known in the art

Inlet port 40 may be connected to exhaust system 16 and configured to receive at least a portion of the exhaust flow from power source 10. Specifically, inlet port 40 may be disposed downstream of turbines 32 to receive exhaust gases from turbines 32. It is contemplated that inlet port 40 may alternatively be located upstream of turbines 32.

Recirculation particulate filter 42 may be connected to inlet port 40 via a fluid passageway 50 and configured to remove particulates from the portion of the exhaust flow directed through inlet port 40. Recirculation particulate filter 42 may include electrically conductive or non-conductive coarse mesh elements. It is contemplated that recirculation particulate filter 42 may include a catalyst for reducing an ignition temperature of the particulate matter trapped by recirculation particulate filter 42, a means for regenerating the particulate matter trapped by recirculation particulate filter 42, or both a catalyst and a means for regenerating. The means for regenerating may include, among other things, a fuel-powered burner, an electrically-resistive heater, an engine control strategy, or any other means for regenerating known in the art. It is contemplated that recirculation particulate filter 42 may be omitted, if desired.

Mass flow sensor 43 may be configured to measure exhaust flow passing through a fluid passageway 52. Mass flow sensor 43 may embody, for example, a thermal mass flow meter, a laminar flow element, a mass compensated positive displacement roots meter, or any other suitable device configured to measure gaseous flows.

Exhaust cooler 44 may be fluidly connected to recirculation particulate filter 42 via the fluid passageway 52 and configured to cool the portion of the exhaust flowing through inlet port 40. Exhaust cooler 44 may include a liquid-to-air heat exchanger, an air-to-air heat exchanger, or any other type of heat exchanger known in the art for cooling an exhaust flow. It is contemplated that exhaust cooler 44 may be omitted, if desired.

Recirculation valve 46 may be fluidly connected to exhaust cooler 44 via a fluid passageway 54 and configured to regulate the flow of exhaust through recirculation system 18. Recirculation valve 46 may be a spool valve, a shutter valve, a butterfly valve, a check valve, a diaphragm valve, a gate valve, a shuttle valve, a ball valve, a globe valve, or any other valve known in the art. Recirculation valve 46 may be solenoid-actuated, hydraulically-actuated, pneumatically-actuated, or actuated in any other manner.

A flow characteristic of recirculation valve 46 may be related to a flow characteristic of induction valve 22. Specifically, recirculation valve 46 and induction valve 22 may both be controlled such that an amount of exhaust flow entering air induction system 14 via recirculation valve 46 may be related to an amount of air flow entering air induction system 14 via induction valve 22. For example, as the flow of exhaust through recirculation valve 46 increases, the flow of air through induction valve 22 may proportionally decrease. Likewise, as the flow of exhaust through recirculation valve 46 decreases, the flow of air through induction valve 22 may proportionally increase.

Discharge port 48 may be fluidly connected to recirculation valve 46 via a fluid passageway 56 and configured to direct the exhaust flow regulated by recirculation valve 46 into air induction system 14. Specifically, discharge port 48 may be connected to air induction system 14 upstream of compressors 24, such that compressors 24 may draw the exhaust flow from discharge port 48.

Exhaust control system 12 may further include a control system 58. Control system 58 may include a controller 60 in communication with recirculation valve 46 to selectively actuate recirculation valve 46 in response to one or more predetermined conditions. Specifically, controller 60 may be in communication with recirculation valve 46 by way of a communication line 62 and in communication with a sensor 64 via a communication line 66.

Sensor 64 may include a means for detecting the presence of sulfur. For example, sensor 64 may include a sensing element exposed to a fuel supply 68 of power source 10 and configured to detect a component of sulfur within fuel supply 68. Sensor 64 may be further configured to generate a signal indicative of an amount of the sulfur component present within fuel supply 68 and to direct the signal to controller 60. It is contemplated that sensor 64 may alternatively include a sensing element exposed to an exhaust of power source 10 or to a condensate within exhaust system 12 to detect the presence of the sulfur component in the exhaust, or any other means for detecting sulfur known in the art. It is further contemplated that other means of detecting sulfur may be implemented such as detecting a dye mixed within a high sulfur fuel by a fuel supplier or any other means for detecting sulfur known in the art.

Controller 60 may be configured to modify the amount of exhaust directed back into power source 10 in response to the signal generated by sensor 64. For example, controller 60 may be configured to compare the amount of sulfur detected by sensor 64 to a predetermined amount and to move the valve element of recirculation valve 46 toward a flow blocking position when the detected amount of sulfur exceeds the predetermined amount. In one example, the predetermined amount may be in the range of about 50-70 ppm. When in the flow blocking position, the flow of exhaust into air induction system 14 from recirculation system 18 may be substantially stopped.

Controller 60 may also be configured to log a fault condition in response to the signal from sensor 64. In particular, controller 60 may be configured to log a fault condition when the sulfur presence detected by sensor 64 exceeds the predetermined amount. It is also contemplated that, rather than or in addition to logging a fault condition, controller 60 may track and record the detected sulfur presence.

Controller 60 may embody a single microprocessor or multiple microprocessors that include a means for modifying the amount of exhaust directed form recirculation system 18 back into air induction system 14. For example, controller 60 may include a memory, a secondary storage device, and a processor, such as a central processing unit or any other means for modifying the flow of recirculation gas known in the art. Numerous commercially available microprocessors can be configured to perform the functions of controller 60. It should be appreciated that controller 60 could readily embody a general power source microprocessor capable of controlling numerous power source functions. Various other known circuits may be associated with controller 60, including power supply circuitry, signal-conditioning circuitry, solenoid driver circuitry, communication circuitry, and other appropriate circuitry.

### INDUSTRIAL APPLICABILITY

The disclosed exhaust control system may be applicable to any combustion-type device such as, for example, an engine, a furnace, or any other combustion device known in the art where the recirculation of sulfur-containing exhaust gas may be damaging to the exhaust control system. Exhaust control system 12 may be a simple, inexpensive, and compact solution to reducing the amount of exhaust emissions discharged to the environment, while protecting the combustion-type device and exhaust control system 12 from the harmful affects of sulfur. The operation of exhaust control system 12 will now be explained.

Atmospheric air may be drawn into air induction system 14 via induction valve 22 to compressors 24 where it may be pressurized to a predetermined level before entering combustion chamber 20 of power source 10. Fuel from supply 68 may be mixed with the pressurized air before or after entering combustion chamber 20. This fuel-air mixture may then be combusted by power source 10 to produce mechanical work and an exhaust flow containing gaseous compounds and solid particulate matter. The exhaust flow may be directed from power source 10 to turbines 32 where the expansion of hot exhaust gasses may cause turbines 32 to rotate, thereby rotating connected compressors 24 and compressing the inlet air. After exiting turbines 32, the exhaust gas flow may be divided into two flows, including a first flow redirected to air induction system 14 and a second flow directed to the atmosphere.

As the first exhaust flow moves through inlet port 40 of recirculation system 18, it may be filtered by recirculation particulate filter 42 to remove particulate matter prior to communication with exhaust cooler 44. The particulate matter, when deposited on the mesh elements of recirculation particulate filter 42, may be passively and/or actively regenerated.

The flow of the reduced-particulate exhaust from recirculation particulate filter 42 may be cooled by exhaust cooler 44 to a predetermined temperature and then directed through recirculation valve 46 to be drawn back into air induction system 14 by compressors 24. The recirculated exhaust flow may then be mixed with the air entering combustion chambers 20. The exhaust gas, which is directed to combustion chambers 20, may reduce the concentration of oxygen therein, which in turn lowers the maximum combustion temperature within power source 10. The lowered maximum combustion temperature may slow the chemical reaction of the combustion process, thereby decreasing the formation of nitrous oxides. In this manner, the gaseous pollution produced by power source 10 may be reduced without experiencing the harmful effects and poor performance caused by excessive particulate matter being directed into power source 10.

The ratio of cooled and reduced-particulate exhaust from recirculation system 18 relative to inlet air may be regulated by recirculation valve 46 and induction valve 22. As described above, the flow positions of recirculation valve 46 and induction valve 22 may be related. As the flow of inlet air into power source 10 via induction valve 22 increases, the flow of cooled reduced-particulate exhaust into power source 10 decreases. Similarly, as the flow of inlet air into power source 10 via induction valve 22 decreases, the flow of cooled reduced-particulate exhaust into power source 10 increases.

As the second flow of exhaust leaves turbines 32, it may be filtered by a second particulate filter (not shown) to remove particulate matter and/or directed through a catalyst to remove other pollutants from the exhaust. Similar to recirculation particulate filter 42, the second particulate filter may also be passively and/or actively regenerated to reduce the amount of HC, CO, and/or particulate matter exhausted to the atmosphere.

The flow of exhaust through recirculation system 18 may be modified in response to an amount of sulfur detected in fuel supply 68. In particular, a high amount of sulfur (e.g., an amount exceeding the predetermined amount of about 50-70 ppm) may result in acidic deposits on the components of recirculation system 18 and air induction system 14. For example, sulfuric acid may condense on exhaust cooler 44 and/or mass flow sensor 43 before water condensation occurs. In addition, condensate having high acidity levels may form on air cooler 26, as the mixture of exhaust and air flows into power source 10. If left unchecked, these acidic deposits may result in increased wear of the components of recirculation system 18 and air induction system 14, and malfunctioning of mass flow sensor 43. In order to minimize the amount of sulfur components allowed into recirculation system 18 and air induction system 14, the valve element of recirculation valve 46 may be moved toward the flow blocking position in response to the detected sulfur presence exceeding the predetermined amount.

When diagnosing failures of power source 10 and/or determining warranty coverage it may be useful to know if fuels having high levels of sulfur have been burned within power source 10. In particular, because the presence of sulfur within fuel supply 68 may reduce the component life and functionality of air induction and recirculation systems 14, 18, certain failures may be directly attributable to the use of high-sulfur fuels. For the same reason, certain warranty coverage may be voided by the use high-sulfur fuels. To facilitate diagnostics of power source 10 and warranty coverage determination, controller 60 may log a failure event when a detected sulfur level exceeds the predetermined amount, and/or record the sulfur levels as they are detected by sensor 64.

Because controller 60 may automatically change operation of recirculation system 18 in response to the detected presence of sulfur, the reliability of power source 10 may be improved. In particular, by changing the operation of recirculation system 18, the components of recirculation and air induction systems 18, 14 may be exposed to lower levels of sulfur of for shorter periods of time, potentially extending the life of the these components. In addition, because sensor 64 may detect the presence of sulfur in the fuel supplied to power source 10 rather than in the exhaust from power source 10, the components upstream of the exhaust may receive protection from the adverse affects of sulfur not afforded with downstream exhaust detection.

It will be apparent to those skilled in the art that various modifications and variations can be made to the disclosed exhaust control system. Other embodiments will be apparent to those skilled in the art from consideration of the specification and practice of the disclosed exhaust control system. It is intended that the specification and examples be considered as exemplary only, with a true scope being indicated by the following claims and their equivalents.

1. An exhaust control system for a power source, comprising:
an air induction system;
an exhaust system;
a recirculation system configured to direct at least a portion of an exhaust flow from the exhaust system to the air induction system;
a sensor configured to detect the presence of sulfur in a fuel supplied to the power source; and
a controller in communication with the sensor and configured to modify operation of the recirculation system in response to the detected presence of sulfur.

2. (canceled)

3. The exhaust control system of claim 1, wherein the controller is configured to stop the direction of the at least a portion of the exhaust flow in response to the detected sulfur presence exceeding a predetermined amount.

4. The exhaust control system of claim 3, wherein the predetermined amount is in the range of about 50-70 ppm.

5. The exhaust control system of claim 3, wherein the controller is further configured to log a fault condition when the detected presence of sulfur exceeds the predetermined amount.

6. The exhaust control system of claim 3, wherein the recirculation system includes a control valve having a valve element movable between a flow passing position, at which the at least a portion of the exhaust flow is allowed to flow to the air induction system, and a flow blocking position, at which the at least a portion of the exhaust flow is substantially prevented from flowing to the air induction system.

7. The exhaust control system of claim 6, wherein the controller is configured to move the valve element of the control valve toward the flow blocking position to stop the direction of the at least a portion of the exhaust flow into the air induction system.

8. A method of operating an exhaust control system, comprising:
directing at least a portion of an exhaust flow from a power source back into the power source for subsequent combustion;
detecting the presence of sulfur in a fuel supplied to the power source; and
modifying an amount of the exhaust flow directed back into the power source in response to the detected presence of sulfur.

9. (canceled)

10. The method of claim 8, further including stopping the directing of the at least a portion of exhaust gas back into the power source in response to the detected presence of sulfur exceeding a predetermined amount.

11. The method of claim 10, wherein stopping the directing of the at least a portion of exhaust gas includes moving a valve element from a flow passing position to a flow blocking position.

12. The method of claim 10, wherein the predetermined amount is in the range of about 50-70 ppm.

13. The method of claim 10, further including logging a fault condition when the detected presence of sulfur exceeds the predetermined amount.

14. A power system, comprising:
a power source including:
an air induction system; and
an exhaust system;
a recirculation system configured to direct at least a portion of an exhaust flow from the exhaust system to the air induction system;
a sensor configured to detect the presence of sulfur in a fuel supplied to the power source; and
a controller in communication with the sensor and configured to modify operation of the recirculation system in response to the detected presence of sulfur.

15. (canceled)

16. The power system of claim 14, wherein the controller is configured to stop the direction of the at least a portion of the exhaust flow in response to the detected sulfur presence exceeding a predetermined amount.

17. The power system of claim 16, wherein the predetermined amount is in the range of about 50-70 ppm.

18. The power of claim 16, wherein the controller is further configured to log a fault condition when the detected presence of sulfur exceeds the predetermined amount.

19. An exhaust control system for a power source, comprising:
a means for directing air into the power source;
a means for directing exhaust from the power source;
a means for directing an amount of the exhaust back into the power source;
a means for detecting the presence of sulfur in communication with a fuel supply of the power source; and
a means for modifying the amount of exhaust directed back into the power source in response to the detected presence of sulfur.

20. (canceled)

21. The exhaust control system of claim 19, wherein the means for modifying includes a controller configured to stop directing exhaust back into the power source in response to the detected sulfur presence exceeding a predetermined amount.

22. The exhaust control system of claim 21, wherein the controller is further configured to log a fault condition when the detected presence of sulfur exceeds the predetermined amount.
